(19) United States
(12) Patent Application Publication
(10) Pub. No.: US 2017/0247106 A1
(43) Pub. Date: Aug. 31, 2017

(54) DRONE PROVIDED WITH FOLDABLE DRONE SUPPORTS

(71) Applicant: PARROT DRONES, Paris (FR)

(72) Inventors: Thierry SANLAVILLE, PARIS (FR); Maxime DUCLOUX, MEREVILLE (FR); Flavien MORRA, Pantin (FR); Karim FARGEAU, Paris (FR)

(73) Assignee: PARROT DRONES, Paris (FR)

(21) Appl. No.: 15/442,443

(22) Filed: Feb. 24, 2017

(30) Foreign Application Priority Data
Feb. 25, 2016 (FR) 16 51568

(51) Int. Cl. B64C 25/20; B64C 39/02

(52) U.S. Cl. CPC B64C 25/20; B64C 39/024; B64C 2201/024; B64C 2201/108; B64C 2201/165

(57) ABSTRACT

Disclosed are embodiments of a rotary-wing drone that includes a drone body, linking arms that extend from the drone body with a propulsion unit located on a distal end of the linking arms, and at least two drone supports extending from the drone body. The drone supports may include a lifting means so that the drone supports are able to be lifted when the drone flies, where the drone supports come into alignment with the linking arms. The drone supports may form the leading edge of the rear linking arms and/or the trailing edge of the front linking arms of the drone.

### CROSS RELATED APPLICATIONS

This application claims priority to French patent application No. 16-51568 filed on Feb. 25, 2016.

### TECHNICAL FIELD

The disclosed technology relates generally to motorized flying devices, such as drones. More specifically, the disclosed technology relates to drones with rotary wings.

### BACKGROUND

Examples of drones with rotary wings of the quadricopter type may be the AR Drone, the Bebop drone, or the Bebop 2 drone of Parrot SA, Paris, France. These exemplary drones are a quadricopter (four propulsion units) equipped with a series of sensors, such as accelerometers, three-axes gyrometers, altimeters and the like. Additionally, the drone may also include a front video-camera capturing images of the scenic environments to which the drone is directed.

Such drones today include various video sensors onboard its structure or support. These sensors may be, for example, a video camera, a 360 degree camera, or a stereoscopic camera.

Such video sensors may be frequently positioned under the drone and directly connected to the lower structure of the drone or on a support that is connected to the lower structure of the drone.

However, such a drone configuration may have the following drawbacks: the drone feet may cover at least part of the field of view of the video sensor, or may even perhaps cover the entire field of view when the video sensor is a 360 degree camera. The drone supports, which help the drone rest in a stable portion when placed on the ground, thus may disturb the quality if the image and corrupt the visual aspect of the video sequence.

While some drones propose to fold these drone supports while the drone is in flight so that the drone supports are then removed from the video sensor's field of view, they fail to take into consideration the drone's aerodynamic behavior. As a result, there is a significant form of drag, which then significantly reduces the flight performance and whole energy efficiency of propulsion.

### BRIEF SUMMARY OF EMBODIMENTS

According to various embodiments, disclosed are drones with a plurality of linking arms connected to the drone that may be folded over along the drone body. By allowing the linking arms to fold, this provides a more compact drone configuration and allows for the drone to be more easily transported and carried around.

Such drones may be equipped with several rotors driven by respective motors adapted to be controlled in a differentiated manner in order to pilot the drone with regards to altitude and speed. Additionally, such drones may include four propulsion units that are each provided with a propeller. The propulsion units may be positioned at the distal end of the link arms, thus connecting the propulsion units to the drone body. Furthermore, these drones may include a plurality of drone supports or feet for supporting the drone, and in particular, when the drone is on the ground.

The piloting of the drone may be done through a touch-screen multimedia telephone or tablet that has accelerometers integrated into them, such as smartphones of the iPhone type or a table of the iPad type (registered trademarks).

The commands emitted by the piloting device many include 4 commands, namely the roll rotation (i.e., the rotational movement about its longitudinal axis), the pitch (i.e., the rotational movement about its transverse axis), the heading also called yaw (i.e., the direction in which the drone is oriented), and the vertical acceleration.

The piloting device may incorporate various control elements required for the detection of the piloting commands and the bi-directional exchange of data via a radio link of the Wi-Fi (IEEE 802.11) or Bluetooth wireless local network type that are established directly with the drone. The touch screens may display the image captured by the front camera of the drone and may also superimpose a certain number of symbols that allow it to control the flight by a simple touch of the operator's fingers on the touch screen.

The bi-directional wireless radio link includes an uplink (from the tablet to the drone) and a downlink (from the drone to the tablet) to transmit data frames that include:
piloting commands from the table to the drone, hereinafter simply denoted “commands” sent at regular intervals and on systematic basis;
the video stream from the drone to the tablet coming from the camera; and
flight data from the drone to the tablet established by the drone or state indicators such as: battery levels; phase of flight (i.e., takeoff, automatic stabilization, landing status, etc.), altitude, detected errors, etc.

Additionally, according to various embodiments, the drone may also include:
drone supports that include two feet connected to each other by a central section, where the central section is adapted to pivot in order to lift the feet of the drone supports;
lifting mechanism or a means for lifting a drone support, which may include a lifting rod and the lifting control device. The lifting control device may further include pivoting lifting cranks that are connected by a coupling means or mechanism to the drone support lifting rod so as to allow for the lifting of the drone supports;
the lifting crank that drives the lifting control device into rotation with a rotation spindle at one end of the lifting crank. At the other end of the lifting crank, a coupling means or mechanism may be included to cooperate with the lifting rod.
a gear motor for driving the rotation spindle of the lifting crank;
a pivoting articulation means located at the central part of the linking mechanism or means so that the drone support may pivot. The two branches of the drone support may extend from the central part and form an angle between each other, where one of the branches includes a lifting rod connected to a lifting crank of the lifting control device, and the second branch is integral with the drone support; and
locking/unlocking means on the drone supports so as to lock and unlock the drone supports from the drone body.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a perspective view of a drone and the associated piloting device according to one particular embodiment.

FIG. 2 illustrates a perspective view of a drone according to one particular embodiment.

FIG. 3A illustrates a drone with linking arms folded according to one particular embodiment.

FIG. 3B illustrates a drone with linking arms folded according to one particular embodiment.

FIG. 3C illustrates a side cross-sectional view of a drone with linking arms folded according to one particular embodiment.

FIG. 4 illustrates a drone folding its linking arms according to one particular embodiment.

FIG. 5A illustrates a mechanism for locking and unlocking the folding of the linking arms of a drone according to one particular embodiment.

FIG. 5B illustrates a mechanism for locking and unlocking the folding of the linking arms of a drone according to one particular embodiment.

FIG. 6 illustrates a method for folding the linking arms of the drone according to one particular embodiment.

FIG. 7 illustrates a propulsion unit with a power cable trough according to one particular embodiment.

FIG. 8 illustrates a support system of a drone according to one particular embodiment.

FIG. 9 illustrates a method for lifting the support system of a drone according to one particular embodiment.

FIG. 10 illustrates a locking mechanism of a drone according to one particular embodiment.

FIG. 11 illustrates a drone with its support system lifted according to one particular embodiment.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

The following description is not to be taken in a limiting sense, but is made merely for the purpose of describing the general principles of the disclosed embodiments. The present embodiments address the problems described in the background while also addressing other additional problems as will be seen from the following detailed description. Numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

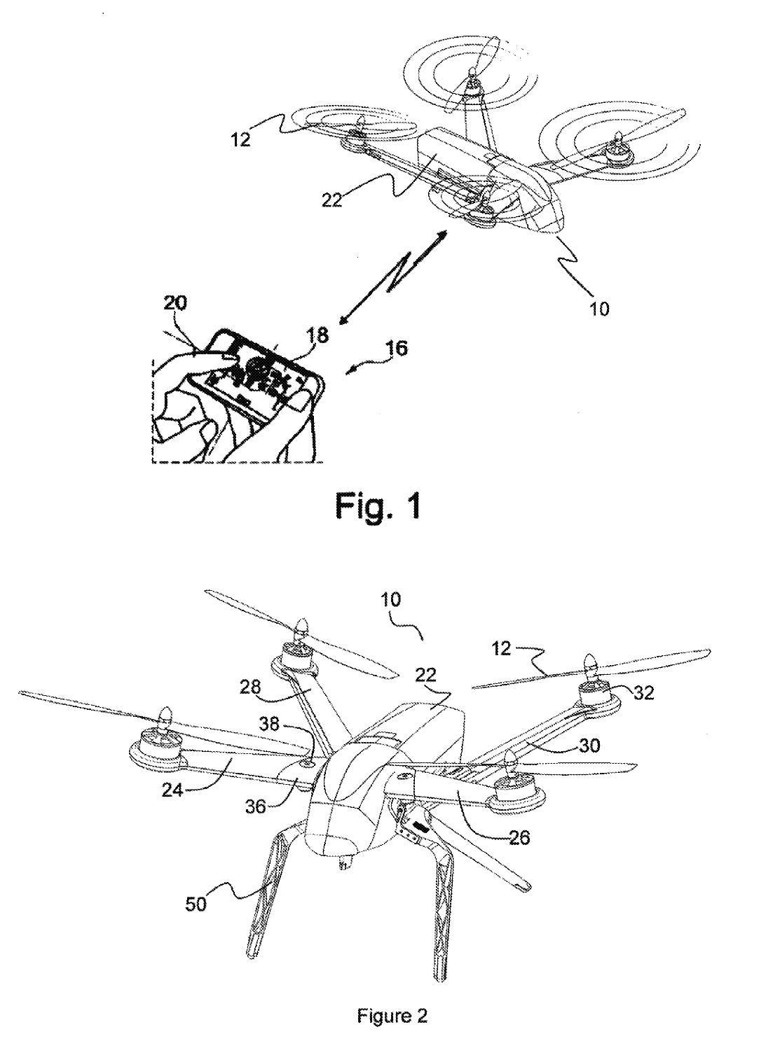

FIG. 1 illustrates a perspective view of a drone and the associated piloting device according to one particular embodiment. According to the example illustrated in FIG. 1, the drone 10 may be a quadricopter. By way of example only, a quadricopter drone includes a drone body 22 and two front linking arms and two rear arms extending from the drone body 22. The drone body 22 may also include four propulsion units 12 located at the distal end of the two front linking arms and the two rear linking arms, where the front and rear positions of the linking arms are defined with respect to the main direction of flight of the drone 10.

The propulsion units 12 may be piloted independently from each other with the use of an integrated navigation and altitude control system.

The drone 10 may also include a front-view camera (not shown here) that makes it possible to obtain an image of the scene towards which the drone is directed. The drone may also include a vertical-view camera (not shown here) pointing downward, which may be adapted to capture successive images of the overflown terrain. This may be used in particular to elevate the speed of the drone with respect to the ground.

According to an exemplary embodiment, the drone 10 may be provided with inertial sensors (i.e., accelerometers and gyrometers) making it possible to measure with certain accuracy the angular speeds and altitude angles of the drone 10 (i.e., Euler angles—pitch, roll, and yaw) to describe the angular inclination of the drone 10 with respect to a horizontal plane of a fixed terrestrial reference system. It is well understood that the two longitudinal and transverse components of the horizontal speed are closely linked to the inclination according to the two respective pitch and roll axes. By way of further example, an ultrasonic range finder may be arranged under the drone 10 to provide a measurement of the altitude with respect to the ground.

The drone 10 may be piloted by a remote piloting device 16, such as a touchscreen multimedia telephone or tablet having integrated accelerometers. For example, a smart phone such as an iPhone or a tablet such as an iPad may be used as a remote piloting device 16. Such devices may load specific applicative software to control the piloting of the drone 10. According to this embodiment, the user may control the displacement of the drone 10 in real time via the remote piloting device 16.

The remote piloting device 16 may be an apparatus with a touch screen 18 that displays the image captured by the camera (not shown here) on-board the drone 10. The touch screen 18 may further display a number of symbols that activate commands to the drone by simple contact of a user's finger 20 on the touch screen 18. The remote piloting device 16 may communicate with the drone 10 via a bidirectional exchange of data by a wireless link of the Wi-Fi (IEEE 802.11) or Bluetooth local network type. From the drone 10 to the remote piloting device 16, the image captured from the camera may be transmitted. Additionally, the piloting commands may be further transmitted from the piloting device 16 to the drone 10.

FIG. 2 illustrates a perspective view of a drone according to one particular embodiment. Here, the exemplary quadricopter drone 10 has a drone body 22 and two front linking arms 24, 26 and two rear linking arms 28, 30 extending from the drone body 22. The drone body may further include a propulsion unit 32 that includes a propeller 12 located at the distal ends of the two front linking arms 24, 26 and two rear linking arms 28, 30 so that each has a propulsion unit.

The drone 10 may have a particular frame structure. By way of example, such a particular frame structure may include a “VTail” shape at the rear end of the drone with respect to the main displacement of flight of the drone 10. In other words, the frame may be modified in such a manner so that the two rear linking arms 28, 30 form a “V” shape. Hence, the points of fixation of the two front linking arms 24, 26 to the drone body 22 and the points of fixation of the two rear linking arms 28, 30 to the drone body 22 are located at different respective heights with respect to the horizontal median plane of the drone body 22.

Furthermore, the two front linking arms 24, 26 of the drone may form a first angle of inclination with respect to the horizontal median plane of the drone body 22 and the two rear linking arms 28, 30 form a second angle of inclination with respect to the horizontal median plane of the drone body 22, in which the second angle is different from the first angle.

In accordance to an exemplary embodiment, the two front linking arms 24, 26 of the drone 10 may form an angle of about 0° to 10° with respect to the horizontal median plane of the drone body 22, and the two rear linking arms 28, 30 form an angle between 15° to 45°. According to one particular embodiment, the angle relative to the two rear linking arms 28, 30 is about 30°.

The propellers 12 may be assembled to the propulsion units 32 of the front arm 26 and the rear arm 30, where they are positioned on the same plane, in particular, the same plane of rotation. Additionally, the propellers 12 may also be assembled to the propulsion units 32 of the other front arm 24 and the other rear arm 28, which are positioned on the same plane, in particular, the same plane of rotation. In other words, the propellers 12 assembled to the propulsion units 32 on the same side of the drone 10 are positioned along the same plane, in particular, the same plane of rotation. The side of the drone 10 may be defined with regard to the main direction of flight of the drone 10.

The propellers 12 may be adapted to be disassembled from the propulsion unit 32, either to be stored or to be changed in instances where the propellers are damaged.

According to one particular embodiment, the propellers 12 may be assembled to the propulsion units 32 of the front linking arms 24, 26 such that the propellers 12 are 279 millimetres in diameter. Additionally, the propellers 12 assembled to the propulsion units 32 of the rear linking arms 28, 30 may be assembled so that the propellers 12 are 220 millimetres in diameter. However, it should be noted that these are only exemplary dimension and that any other dimensions may be used.

According to a particular embodiment, the quadricopter drone 10 may be adapted to transport different on-board sensors. The sensors may be fixed to the drone body 22. In particular, the sensors may be inserted onto a drone support 50, and hooked to the lower external structure of the drone 10.

By way of example only, the sensors on-board the drone 10 may be a camera. The camera may be a 360-degree camera or a stereoscopic camera.

The drone 10 may also include at least one drone support 50. As illustrated in FIG. 2, the drone 10 may include two drone supports 50, where each includes two feet-like structures.

The drone 10, due to its structure, has important bulk. As result, one of its drawbacks is that the quadricopter done 20 may be difficult to transport and carry around.

In order the satisfy this requirement, the linking arms 24, 26, 28, 30 of the drone 10 may be adapted to be folded along the drone body 22 in order to reduce the bulk of the quadricopter drone 10 during its transportation.

Additionally, the drone 10 may also include a protrusion 36, in which the linking arms 24, 26, 28, 30 are fixed. The linking arms 24, 26, 28, 30 may also include a locking/unlocking means 38 to ensure that the linking arms 24, 26, 28, 30 are fixed in place. More information is detailed below.

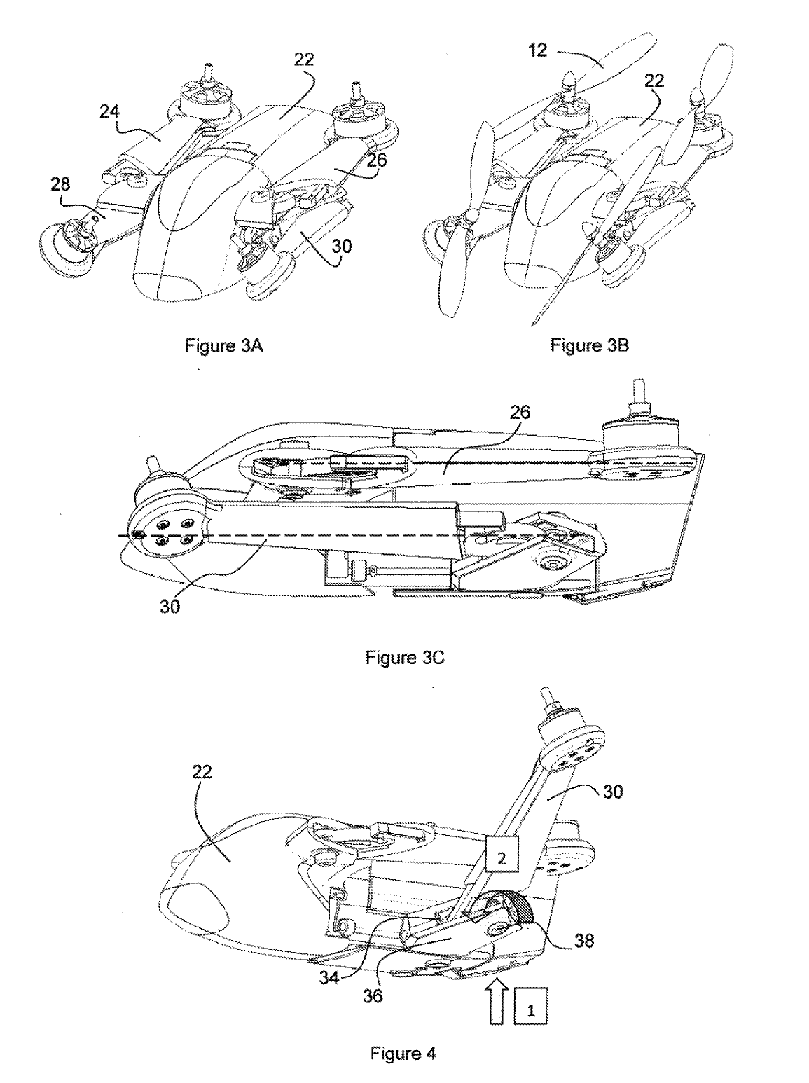

FIG. 3A illustrates a drone with linking arms 24, 26, 28, 30 folded according to one particular embodiment. As illustrated, the drone may be folded into a easily transportable configuration so that the propellers have been disassembled and the linking arms 24, 26, 28, 30 are folded along the drone body 22.

However, in an alternative embodiment, the linking arms 24, 26, 28, 30 may be folded while keeping the propellers assembled onto the propulsion units of the of the drone, as illustrated in FIG. 3B.

Referring to both FIGS. 3A and 3B, the linking arms 24, 26, 28, 30 may be folded by pairs, such that linking arms 24, 28 are one pair and linking arms 26, 30 are another pair. The linking arms 24, 26, 28, 30 may be folded one over the other. In particular, when the linking arms 24, 26, 28, 30 are folded over, the linking arms 24, 26, 28, 30 as a pair of arms may extend in the respective planes parallel to each other and may further extend on either side of the horizontal median plane of the drone body 22, as further illustrated in FIG. 3C. For this purpose, the linking arms 24, 26, 28, 30 may be respectively connected to the drone body 10 by a pivoting means. The pivoting means or mechanism 34 may include a folding locking/unlocking means 38, as shown in FIG. 4. Indeed, FIG. 4 illustrates a drone folding its linking arm 30 according to one particular embodiment.

According to an exemplary embodiment, as illustrated in FIG. 4, the pivoting means 34 is positioned substantially outside the main profile of the drone body 22. For that purpose, the drone body 22 includes linking arms 30 on a protrusion 36 on which the pivoting means 34 is positioned.

As further illustrated in FIG. 4, the locking/unlocking means 38 is positioned under the linking arms 30.

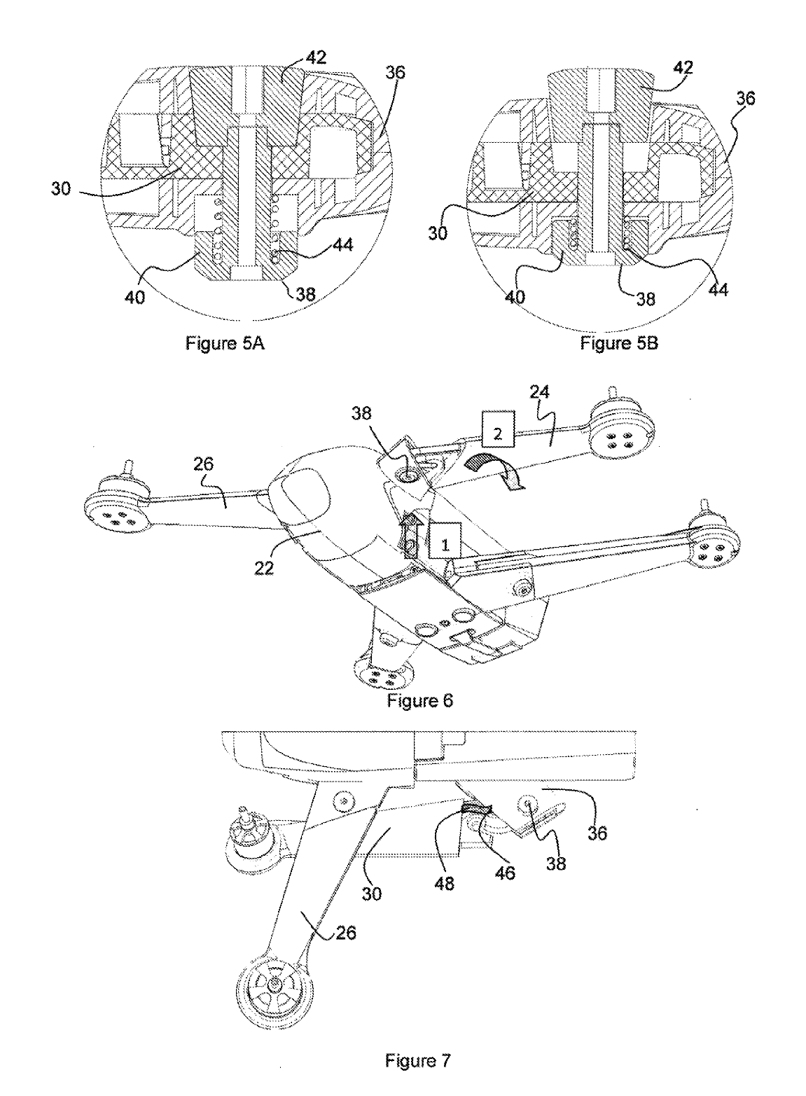

FIG. 5A illustrates a mechanism for locking and unlocking the folding of the linking arm 30 of a drone according to one particular embodiment. FIG. 5B illustrates a mechanism for locking and unlocking the folding of the linking arm 30 of a drone according to one particular embodiment. As such, FIGS. 5A and 5B will be explained herein together. According to a particular embodiment, the folding locking means 38, as illustrated in FIGS. 5A and 5B, include at least two positions, i.e., a locked position when the linking arm 30 is unfolded and an unlocked position when the linking arm 30 is in a folded position. When in an unfolded position, the linking arms 30 may be configured to be later folded or folded over.

The locked position of the folding locking/unlocking means 38 allows for the linking arm 30 to be in the unfolded position. In other words, the locked position allows holding the linking arm 30 to be in its normal position to allow for the proper flight of the drone 10. Moreover, the locking means 38 avoids any non-desired folding-over incident, in particular, during flight.

Furthermore, according to an exemplary embodiment as illustrated in FIGS. 5A and 5B, the folding locking/unlocking means 38 is a press button 40 that may include a locking pin 42 and a spring 44. The locking pin 42 may be conical in shape.

Referring to FIG. 5A, the folding locking/unlocking means 38 is in the locked position, whereas FIG. 5B illustrates the folding locking/unlocking means 38 in the unlocked position. In these figures, the protrusion 36 of the drone body 22, on which the linking arm 30 is fixed, shows the linking arm 30 and the locking/unlocking means 38.

In a locked position, the conical locking pin 42, as illustrated, is simultaneously in contact with the drone body 22 and the linking arm 30 in order to block any movement of one of them relative to the other. In the unlocked position, the conical locking pin 42 is extracted from its position in the linking arm 30 so as to allow a movement of rotation of the linking arm 30. The passage from the locked position to the unlocked position is made through the press button 40.

The folding locking/unlocking means 38 may also include a spring 44 so as to allow for the automatic locking of the folding locking/unlocking means when the protrusion 36 of the drone body and the linking arm 30 are in a “ready to fly” position. According to the now-described folding embodiment, the folding of the linking arms 30 begins by the folding of the front arms 30.

FIG. 6 illustrates a method for folding the linking arms 24, 26 of the drone according to one particular embodiment. For that purpose, as shown in FIG. 6, the folding locking/unlocking means 38, for example the press button, is operated under the linking arms 24, 26. Thus this allows for the front linking arms 24, 26 of the drone 10 to be folded over along the drone body 22. Hence, the front linking arms 24, 26 are folded towards the rear of the drone.

FIG. 7 illustrates a propulsion unit with a power cable trough according to one particular embodiment. As illustrated, the control cable 46 is placed in a cable trough in order to be protected, the trough being present in the linking arm 26 and in the drone body 22. When the linking arms 26 of the drone are folded over, it is observed that the control cable 46 is no longer protected at the pivoting means.

Hence, in order to keep this control cable 46 protected, the control cable 46 is inserted into a grommet 48, so as not to allow a direct access to this cable 46 when the linking arm 26 is in a folded-over position.

As indicated hereinabove, the drone is in particular adapted to take sensors on board its structure, in particular a camera, a 360-degree camera or a stereoscopic camera. Preferably, the sensor is fixed to the drone body 22, on the lower structure of the drone body, or on a support itself fixed to the lower part of the drone body.

However, such a drone configuration has drawbacks. For example, the drone supports, or even all the supports of the drone, may cover the field of view of part or all of the video sensor's field of view. Hence, it is observed that the drone supports entering in the field of view of the sensor may disturb the quality of the video image and even corrupt the visual aspect of the video sequence.

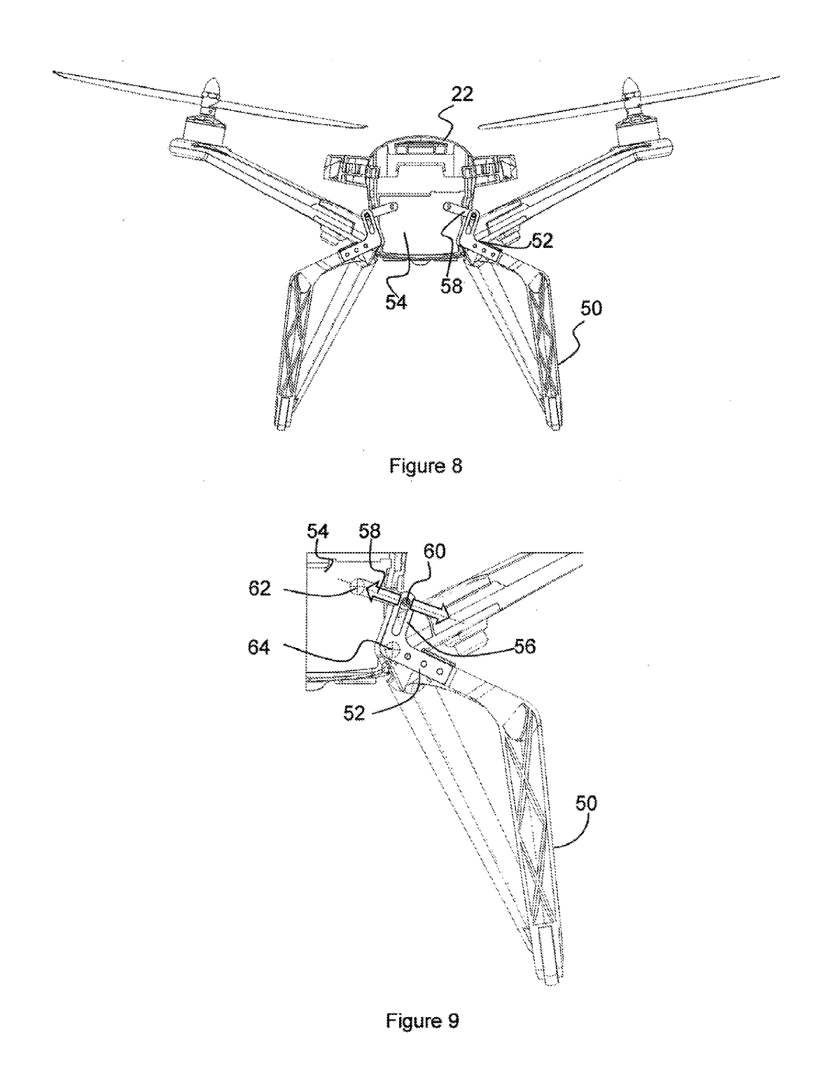

Referring back to FIG. 2, the Figure illustrates a drone 10 with two drone supports 50, each having two feet. FIG. 8 further illustrates a support system of a drone according to one particular embodiment. In one particular embodiment, the supports 50 may include a lifting means or mechanism 52 and a lifting control device 53 linked to the lifting means or mechanism 52. This then allows the supports 50 to be lifted when the drone is in flight.

Hence, such a configuration of the drone supports 50 allow, on the one hand, a landing of the drone in a stable position onto the ground when the drone supports 50 are not lifted. On the other hand, when the drone supports 50 may be lifted during flight. As a result, this allows for a camera (not shown here) attached to the drone to have a clear visual field under the drone when the drone supports 50 are lifted. Indeed, the lifted position of the drone supports 50 allows for the drone support 20 to be eliminated from the visual field of the video sensor so that its video visual quality is not disturbed or interrupted by the feet of the drone supports 50.

FIG. 8 further illustrates a drone body 22 with a lifting control device 54 and the lifting means 52. As illustrated, the drone body 22 may include a lifting control device 54 where in some instances, the lifting control device 54 is a gear box.

The drone may also include drone supports 50 that are affixed to the drone body 22, where the drone supports 50 include a lifting means 52 that cooperate with the lifting control device 54.

FIG. 9 illustrates a method for lifting the support system of a drone according to one particular embodiment. According to a particular embodiment, the lifting means 52 of the drone support 50 includes a lifting means 52 with a lifting rod 56. Moreover, the lifting control device 54 includes pivoting lifting cranks 58, which are connected by a coupling means 60 to the lifting rod 56. This allows for the lifting of the drone supports 50.

According to this embodiment, in the non-lifted position of the drone support 50, the position of the pivoting lifting crank 58 and of the lifting means 52 are in a position that cancels the resulting forces in the lifting control device 54 coming from the weight of the drone. Additionally, this may also eliminate the shock of the drone at the time of impact with the ground when landing the drone.

Referring to both FIGS. 8 and 9, these illustrations show that the pivoting lifting crank 58 may be included and is further driven into rotation by the lifting control device 54. For that purpose, the end of the pivoting lifting crank 58 may be fixed to a rotation axis 62 of the lifting control device 54, where the rotation axis may be driven into rotation by the lifting control device 54.

Additionally, the second end of the pivoting lifting crank 58 may include the coupling means 60 adapted to cooperate with the lifting crank 56 of the lifting means 52. Hence, according to this embodiment, the connecting rod-crank system is implemented.

The coupling means 60 may be an example of a spindle firmly secured to the pivoting lifting crank 58 inserted into the opening of the lifting crank 56. According to another example of implementation of the lifting control device 54, the latter is formed by a gear motor for driving said axis of rotation of the lifting crank 56. Such a gear motor is a unit consisted of a reduction gear and an electric motor. The reduction gear allows reducing the speed of rotation of the electric motor.

As further illustrated in FIG. 9, the lifting means 52 may include a pivoting articulation 64 of the support 50. By way of example, the pivoting articulation 64 includes a pivot axis that is inserted into the drone body in order to allow a rotation of the lifting means 52 according to this axis.

As an alternative, the pivoting articulation 64 of the support 50 is for example, a through-hole of the perforation type, in particular of round shape, into which is a rotation axis of complementary shape is inserted and fastened to the drone body.

The lifting means 52 may include, for example, two branches extending from the central part of the lifting means 52. In particular, the pivoting articulation 64 may form an angle between these branches. The angle formed between the two branches may be between 75 and 105°, and preferentially 90°.

Additionally, according to some embodiments, one of the branches from the lifting means 52 may include the lifting rod 56 connected to a pivoting lifting crank 58 of the lifting control device 54. The second branch from the lifting means 52 may be fastened to the drone support 50. According to this embodiment, the direction of the force exerted on the lifting crank 56 is substantially centred to the pivot axis of the lifting crank 56 and exerts no torque on the latter. The efforts inside the lifting control device 54 are non-existent or very low.

In some embodiments, the lifting control device 54 allows, after the drone has taken off, the lifting of the drone supports 50 in order to free the field of view of the video sensor fixed on the lower surface of the drone body. For this purpose, the lifting control device 54 may be controlled by the piloting device 16, as illustrated in FIG. 1. In particular, the piloting device 16 may include a command that allows for the lifting and lowering of the drone supports 50. This command may be emitted from the piloting device 16 to the drone via the communication link established between the piloting device 16 and the drone.

Thus, upon commands directing for the lifting/lowering of the drone supports, the drone may check and determine whether or not the drone supports 50 are currently in a mode that allows for such commands to be carried out. For example, the lifting command for the drone supports 50 won't be executed when the drone is on the ground. However, if the drone state allows for the execution of the command, then the command piloted by the drone control device 54 will be executed.

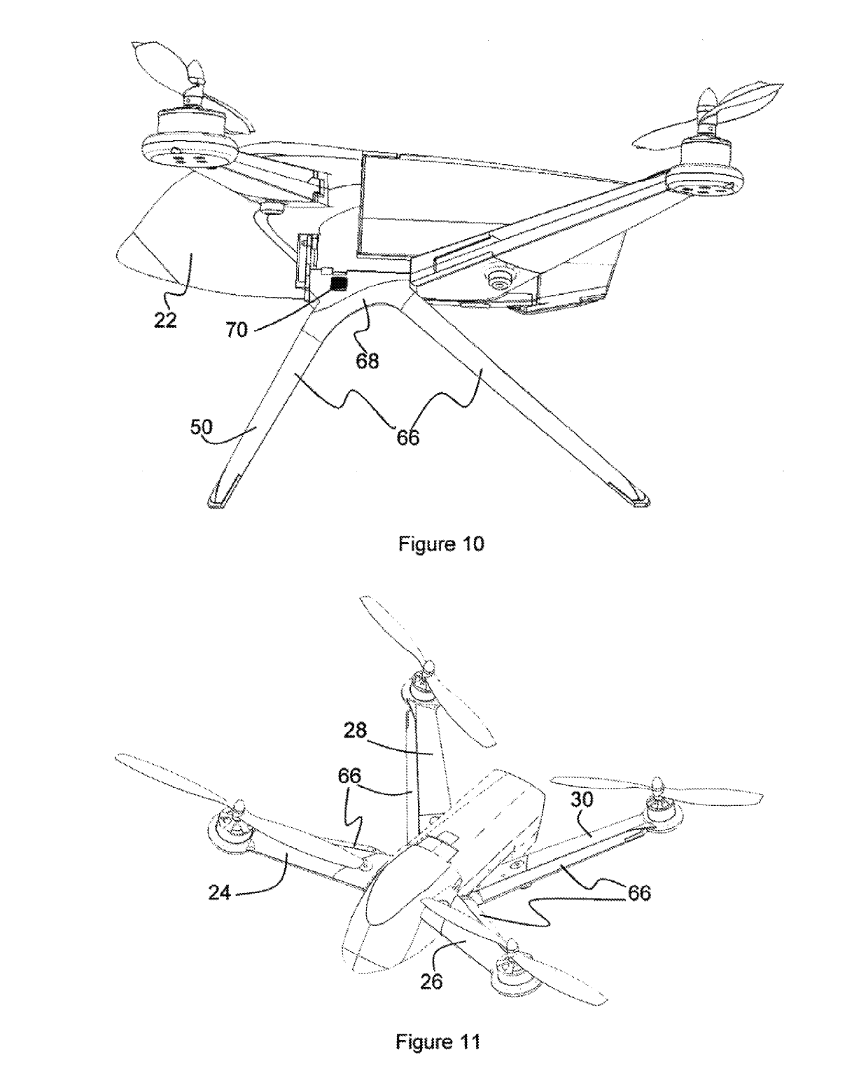

FIG. 10 illustrates a locking mechanism of a drone according to one particular embodiment. Here, the drone includes two supports 50, where each drone support 50 includes two feet 66 connected to each other by a central section 68.

According to a particular embodiment illustrated in FIG. 10, the central section 68 of the drone support 50 is adapted to pivot to allow the lifting of the feet.

According to a particular embodiment, the drone supports 50 are adapted to be separated from the drone body 22. In particular, this then allows the bulk of the drone to be reduced, which facilitates the transporting of the drone. For that purpose and as illustrated in FIG. 10, the drone supports include a means 70 for locking/unlocking the drone supports on the drone body.

The means for locking/unlocking the drone supports is adapted to firmly hold the drone support to the drone body 22 in the locked position. Moreover, in the unlocked position, the drone support is adapted to be removed from the drone body 22, so that the drone support lifting means 52 may be disassembled from the lifting control device (see FIGS. 8 and 9). FIGS. 8 and 9 will be explained in conjunction with FIG. 10 to describe the locking/unlocking of the drone supports 50 from the drone body.

More specifically, the method to disassemble the support lifting means 52 from the lifting control device 54 may include two steps. Additionally, this method may be advantageous because additional tools are not needed.

For example, the first step may include operating on the means 70 for locking/unlocking the drone supports 50 in order to unlock said means 70 to separate the drone supports 50 from the drone body 22. The second step may include displacing the drone support 50 towards the front of the drone, where the front of the drone is defined as the main direction of flight of the drone. This displacement allows for example separating the lifting means 52 from the lifting crank 58, and hence ultimately from the lifting control device 54. Moreover, this displacement allows separating the lifting means 52 from the pivoting articulation 64 of the drone body 22. Once the lifted means 70 are separated from the lifting crank 58 and from the pivoting articulation 64, the drone support 50 is adapted to be removed from the drone.

FIG. 11 illustrates a drone with its support system lifted according to one particular embodiment. Here, the drone supports 50 are in alignment with the linking arms 24, 26, 28, 30 during the flight of the drone (i.e., the linking arms 24, 26, 28, 30 are unfolded and the drone supports 50 are folded over).

From the aerodynamic point of view, this arrangement gives the linking arms 24, 26, 28, 30 the configuration of a profiled body that makes it possible to practically suppress the drag peculiar to the supports 50. Thus, drag that would otherwise be added to the proper drag generated by the linking arms 24, 26, 28, 30 is reduced (the drag being defined as the force that comes against the movement of the drone supports 50 in the air).

The drone supports 50 form the leading edge of the rear linking arms 28, 30 positioned at the rear of the drone and a trailing edge at the front linking arms 24, 26 at the front of the drone.

This then allows the drag, defined as the force that comes against the movement of the drone supports in the air, to be suppressed during the drone flight. For this purpose, the drone supports in the lifted position are integrated in the shape of the drone linking arms 24, 26, 28, 30, to reconstitute a shape of the “plane wing” type, i.e. having an airfoil, with a leading edge and a trailing edge, allowing the drag of the supports to be reduced during the drone flight. Moreover, it is observed that, according to the embodiment illustrated in FIG. 11, the drone supports in the lifted position ensure an additional system of locking in flight, in particular in the case of folding linking arms 24, 26, 28, 30. Moreover, the drone supports in the lifted position reinforce structurally the linking arms 24, 26, 28, 30 during the drone flight.

Thus, the whole drone supports lifting system as described herein, by way of example only, includes a drone with two front linking arms 24, 26 attached to the drone body 22 and two rear linking arms 28, 30 also attached to drone body 22. The linking arms 24, 26, 28, 30 may be located at different respective heights with respect to the horizontal median plane of the drone body 22, such that the two front linking arms 24, 26 form a first angle of inclination with respect to the horizontal median plane of the drone body 22 and two rear linking arms 28, 30 form a second angle of inclination with respect to the horizontal median plane of the drone body 22, where the second angle is different from the first angle.

However, this whole drone supports lifting system may also be adapted to be implemented so that the two front linking arms 24, 26 and the two rear linking arms 28, 30 of the drone body 22 are located at a same height with respect to the horizontal median plane of the drone body 22. As a result, the two front linking arms 24, 26 of the drone may form a same angle of inclination as the two rear linking arms 28, 30 with respect to the horizontal median plane of the drone body.

Various embodiments have been described with reference to specific example features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various example embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the present application, whether or not such embodiments are described and whether or not such features are presented as being a part of a described embodiment. Thus, the breadth and scope of the present application should not be limited by any of the above-described example embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide illustrative instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed in multiple groupings or packages or across multiple locations.

Additionally, the various embodiments set forth herein are described in terms of example block diagrams, flow charts, and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A drone comprising:
a drone body; and
linking arms extending from the drone body with a propulsion unit at one end of the linking arms;
at least two drone support extending from the drone body, where the drone supports each comprise a lifting mechanism; and
at least one lifting control device linked to the lifting mechanism such that the drone supports are lifted to a lifted position when the drone is in flight;
wherein the drone supports come into alignment with the linking arms when the drone supports are lifted.

2. The drone of claim 1, wherein the lifted position comprises the drone supports to form a leading edge with the linking arms positioned at a rear end of the drone and to form a trailing edge of the linking arms positioned at a front end of the drone.

3. The drone of claim 1, wherein the drone supports comprise two feet connected to each other by a central section, where the central section pivots in order to lift the feet.

4. The drone of claim 1, wherein the lifting mechanism comprises a lifting rod and the lifting control device comprises a pivoting linking crank connected to the lifting rod by a coupling mechanism in order to lift the drone supports.

5. The drone of claim 4, wherein the pivoting lifting crank is driven into rotation by the lifting control device at a first end of the lifting crank through a rotation spindle and a coupling mechanism at a second end of the lifting crank adapted to cooperate with the lifting rod.

6. The drone of claim 5, wherein the lifting control device comprises a gear motor for driving the rotation spindle of the lifting crank.

7. The drone of claim 4, wherein the lifting mechanism comprises a pivoting support articulation in a central part of the lifting mechanism and a first branch and a second branch extending from the central part to from an angle, where the first branch comprises the lifting rod connected to the lifting crank of the lifting control device, and the second branch is integral with the drone support.

8. The drone of claim 1, wherein the drone supports are configured to be separated from the drone body.

9. The drone of claim 8, wherein the drone supports comprise a mechanism for locking and unlocking the drone supports from the drone body.
